(19) United States
(12) Patent Application Publication
(10) Pub. No.: US 2004/0084433 A1
(43) Pub. Date: May 6, 2004

(54) Domestic irons

(76) Inventors: Nicola Jane Field, Rochestown Cork Eire (GB); Jonathan Ezinwa Nwabueze, Surrey (GB)

Correspondence Address: H JAY SPIEGEL, P.O. BOX 444, MOUNT VERNON, VA, 22121, US

(21) Appl. No.: 10/471,088

(22) PCT Filed: Mar. 7, 2002
(86) PCT No.: PCT/GB02/00924

(30) Foreign Application Priority Data
Mar. 7, 2001 (GB) 0105545.8

(51) Int. Cl. H05B 1/00

(52) U.S. Cl. 219/221

(57) ABSTRACT

A domestic manually operable iron intended for use without an ironing board comprises a sole plate (3) containing suction apertures (7) and a fan (8) driven by means of a motor (9) so that, in use, a fabric can be held against the sole plate (3) by the suction effect of air passing through the apertures (7).

This invention relates to a steam facilitated clothes iron particularly the household appliance used for the ironing of clothes.

The task of ironing clothes has been viewed as an arduous necessity in the lives of those in the modern world. The unfolding and re-packing of heavy cumbersome boards which require additional storage space, together with the awkwardness of turning and aligning aspects of garments, such as shirts and blouses, etc., can be difficult, especially to individuals of slight build, the trouble lies in that even when a garment is only slightly but sufficiently creased, this entire physical action needs to be undertaken.

In the modern world, time and efficiency is frequently of the essence. A person may seek to eliminate relatively small areas of creasing in their garment, be this for work or social occasions, with as much ease as possible. If travelling away from home, the prospect of there being an iron and board at a persons destination can not be taken as a certainty, and assuming there is, it must be taken into account that it may be located at some distance from that persons main place of stay, or undress.

The elimination of these problems requires departure from the dependency of the clothes iron on the ironing board preferably in a small compacted lightweight design.

In accordance with the invention there is provided a manually operable domestic iron as defined in claim 1.

Further preferred features and advantages of the invention will become apparent from the subordinate claims taken in conjunction with the following description and the drawings, in which:

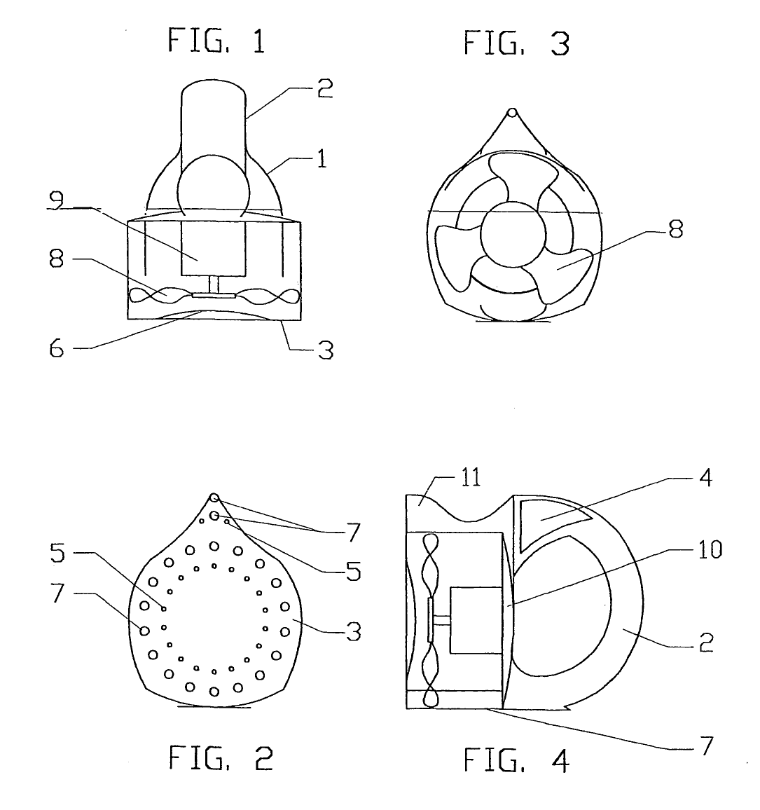

FIG. 1 is a diagrammatic rear elevation of one embodiment of iron in accordance with the invention,

FIG. 2 is a view from the underside of the iron of FIG. 1,

FIG. 3 is a plan view of the iron according to FIG. 1 shown in diagrammatic form to show internal detail,

FIG. 4 is a side elevation of the iron of FIG. 1 shown in diagrammatic form with internal detail,

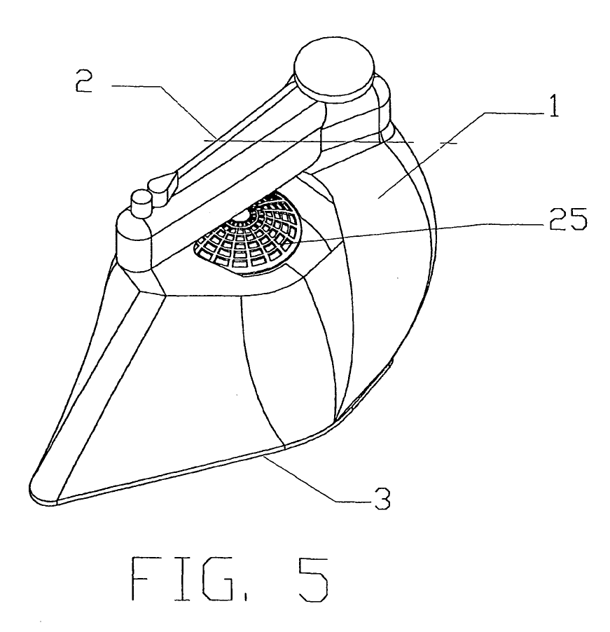

FIG. 5 is a perspective view of a second embodiment of iron in accordance with the invention,

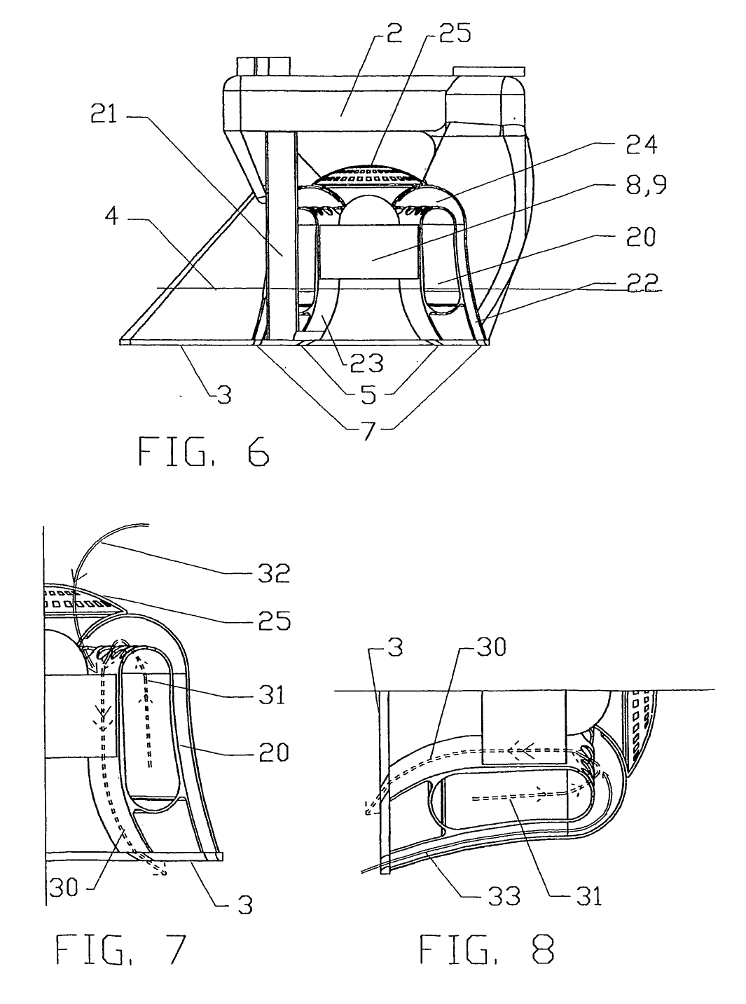

FIG. 6 is a sectional elevation of the iron shown in FIG. 5,

FIG. 7 is a fragmentary view corresponding to FIG. 6, showing air flow paths within the iron when used in a horizontal mode, and

FIG. 8 is a view similar to FIG. 7 showing air flow when the iron is used in a vertical mode.

Referring to FIGS. 1 to 4 of the drawings, a steam iron in accordance with the invention comprises a body portion 1 having a handle 2 and a sole plate 3 that is equipped with the conventional electrical heating element, not shown. As in a conventional steam iron, the iron in accordance with the invention is equipped with a water tank 4 and conventional means for directing water by drip feed from the tank 4 to a heated portion of the sole plate 3 so that water can issue from the sole plate 3 as steam, via outlet apertures 5. The drip feed from the tank 4 to the sole plate is effected within a central steam hub 6 the periphery of which is indicated in broken lines in FIG. 2, and in the outer margin of the sole plate beyond the steam hub 6, there are provided suction inlet apertures 7 (see FIG. 2).

Within a cylindrical central portion of the body 1 is located a fan 8 arranged to be driven by a motor 9 and, in use, the fan 8 serves to draw ambient air through the suction aperture 7 and to discharge the air from an air outlet in the upper part of the body 1 and indicated diagrammatically at 10 in FIG. 4.

As indicated in FIGS. 2 and 4, the sole plate 3 incorporates a beak 11.

In use, the iron illustrated in the drawings can be used for the purpose of ironing fabric without the need to lay the fabric against an ironing board, as the action of the fan drawing air through the suction apertures 7 will be sufficient to hold an area of fabric against the sole plate of the iron so that heat from the sole plate and steam discharged from the apertures 5 will be effective to remove creases from the fabric.

It will be appreciated that an iron in accordance with the invention can be used either in the horizontal mode, with or without a supporting surface for the fabric, and can also be used with the sole plate in a vertical condition, for example to the iron the fabric of a garment whilst supported on a hanger.

Referring to FIGS. 5 to 8 of the drawings, there is shown another embodiment of iron according to the invention, in which parts corresponding to those already described with reference to FIGS. 1 to 4 are indicated with the same reference numerals and will not be described again in detail.

The iron according to the second embodiment of the invention differs from that in FIG. 1, in that steam to be supplied to the steam exit apertures 5 is derived not from water dripped on to the heated sole plate, but from an annular steam chamber 20 that surrounds the fan and motor assembly 8, 9. Water from the reservoir 4 is conducted to the steam chamber 20 by means of a conventional drip feed arrangement, by a manually assisted pump arrangement, or, optionally, by pressurising the reservoir 4 with air derived from the outlet of the fan 8. The steam chamber 20 contains a heating element, not shown, and, below the steam chamber 20 there is additionally provided a heating element, not shown, for the sole plate 3. Wiring from the heating elements and the fan motor is led via a wiring duct 21 to controls not illustrated, on the upper part of the body of the iron.

The suction apertures 7 are coupled to an inlet of the fan 91 by means of an annular air conduit 22, and the outlet of the fan 8 is coupled by means of a further annular conduit 23 to the steam outlet apertures 5. Thus, instead of the air drawn through the suction apertures 7 being discharged from the upper body of the iron, the air is caused to be discharged through the steam exit apertures 5. The steam chamber 20 has outlet apertures 24 in its upper periphery, and the outlet apertures 24 are also coupled to the inlet of the fan 8, so that steam from the chamber 20 is drawn by the fan and discharged through the outlet apertures 5 with the assistance of the air flow.

The upper part of the body 1 of the iron incorporates an additional inlet aperture 25, and thus the volume of air passing through the steam exit apertures 5 can be augmented by an air flow drawn directly from the inlet 25 by the fan 8. The air inlet 25 may be provided with control means, not shown, enabling adjustment of the additional air flow passing to the steam exit apertures 5. For example, the air flow can be augmented when the iron is used in a horizontal position, in order that an increased air cushion effect can be provided beneath the sole plate, for example when the iron is used on a conventional ironing board. In the latter case, the arrangement may also be such that air flow through the suction apertures 7 is reduced or dispensed with altogether.

FIG. 7, for example, shows diagrammatically use of the iron on a horizontal condition, wherein the air flow through the steam exit apertures 5 and indicated by the arrow 30 is made up of steam passing from the chamber 20 and indicated by the arrow 31 and air drawn through the inlet 25 and indicated by the arrow 32.

As shown in FIG. 8, the air flow with the iron in the vertical condition, for example with the sole plate 3 in use for ironing the fabric of clothes held vertically upon a hanger, the air flow 30 through the steam exit apertures 5 is derived from the steam chamber at 31, and from the suction apertures 7, as indicated by the arrow 33.

It will be appreciated that various alterations and modifications may be made to an iron in accordance with the present invention, without departing from the scope of the invention as defined in the appended claims. For example, although the sole plate 3 is provided with a heating element, in some modes of operation of the iron it may be convenient for the sole plate 3 to be cool, or only slightly heated, heat being directed to the fabric to be ironed solely by means of the steam containing air flow through the steam outlet apertures 5. The iron may also be used in a mode in which dry ironing is effected, without generating steam to be passed through the exit apertures 5.

1. A manually operable domestic iron comprising a sole plate for contact with fabric to be ironed, a plurality of suction apertures provided in said sole plate, means for drawing ambient air through said suction apertures via a fabric when in contact with said sole plate, whereby in use the fabric is held in contact with said sole plate by suction, and means for applying heat to said fabric in contact with said sole plate.

2. An iron according to claim 1, said iron including means for generating steam, and wherein said heat applying means comprises a plurality of steam exit apertures provided in said sole plate and arranged to discharge steam from said steam generating means.

3. An iron according to claim 2 wherein said suction apertures are provided in an array around an outer peripheral margin of said sole plate and said steam exit apertures are located in an area of the sole plate bounded by said array of suction apertures.

4. An iron according to any one of claims 1-3 wherein said sole plate is generally circular and the said means for drawing air into said suction aperture comprises a fan arrangement housed vertically in a short cylindrical body.

5. An iron according to claim 4 as appended to claim 2 wherein said sole plate has a beak or nose containing suction apertures and steam exit apertures.

6. An iron according to any one of claims 1-5 including means for heating said sole plate.

7. An iron according to claim 6 as appended to claim 2, wherein said steam generating means includes means for directing a flow of water from a reservoir to said sole plate.

8. An iron according to claim 6 or 7, including means for controlling the heating means to vary the temperature of the sole plate.

9. An iron according to claim 2 or any one of claims 3-6 or 8 as appended thereto, wherein said steam generating means comprises a steam chamber arranged within a body portion of the iron and containing heating means and means for conducting water from a reservoir to said heating means, and wherein the arrangement is such that said means for drawing ambient air through said suction apertures is arranged to discharge said air through said steam exit apertures together with steam discharged from said steam chamber and entrained within the air flowing from said suction apertures to said steam exit apertures.

10. An iron according to claim 8, wherein the iron includes a further air inlet vent in the body of the iron, and said means for drawing ambient air comprises a fan having an air inlet selectively couplable to said air suction apertures and/or said further air inlet, and having an outlet coupled to said steam exit apertures.
